(19) United States
(12) Patent Application Publication
(10) Pub. No.: US 2007/0047770 A1
(43) Pub. Date: Mar. 1, 2007

(54) Multiple biometrics enrollment and verification system

(76) Inventors: Guy G. Swope, Reston, VA (US); Walter Syriant, Vienna, VA (US)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/150,972

(22) Filed: Jun. 13, 2005

(51) Int. Cl. G06F 7/00

(52) U.S. Cl. 382/115; 707/102

(57) ABSTRACT

A system and method for providing quick retrieval of personal medical history profile is disclosed. The method includes maintaining in a database for each of a plurality of individuals a medical history profile and corresponding at least one biometric characteristic. The medical history profile is retrieved from the database based on the at least one biometric characteristic of the individual.

### FIELD OF THE INVENTION

The present invention relates generally to identification systems and, more particularly, to a system and method for storage and retrieval of an individual's medical history using biometric, biographic and/or demographic identification.

### BACKGROUND OF THE INVENTION

A patient's medical history is extremely valuable to a physician and/or other medical personal in evaluating and/or treating the patient. The patient's medical history, for example, can be used to check whether the patient has allergic reactions to specific drugs, whether the patient has any known medical conditions, e.g., diabetes, heart disease, etc., to identify any personal characteristics of the patient, e.g., blood type, age, height, weight, etc., or any other information that is relevant in treating the patient. Thus, it is preferable to have a complete medical history of the patient prior to diagnosing and/or treating the patient. Unfortunately, obtaining the patient's medical history can be time consuming and, as a result, the medical history may not be available at the time diagnosis and/or treatment is required.

Moreover, it may not be possible to quickly identify the patient and, therefore, the medical records cannot be retrieved prior to treatment. For example, if the patient is unconscious due to a head injury or other traumatic injury, the patient cannot communicate his or her identity to medical personnel. Thus, unless the patient is carrying identification, the patient cannot be readily identified and, therefore, retrieving the patient's medical history can be extremely difficult and time consuming. In such situations, the time required to identify and retrieve the patient's medical history usually exceeds the time frame in which the patient requires medical attention. In such circumstances, optimal medical treatment may not be possible.

One way of identifying an individual is through biometric data. Biometric identification describes the process of using one or more biological features to identify a person or other entity. Biometric identification is particularly useful because certain personal characteristics are substantially unique to each person and are difficult to reproduce by an impostor. Further, the recording and analysis of biometric data can be automated, thereby allowing use of computer controlled electronics and digital recording techniques.

The use of biometric data for identification purposes requires that a particular biometric factor is substantially unique for each individual, that it is readily measured and that it is invariant over the time period during which the person may be tested for identification. Further, the biometric data should be difficult to duplicate by an impostor in order to secure against erroneous identification. Some of the biometric characteristics most investigated today for use in personal identification systems include fingerprints, hand or palm prints, and iris or retina scans.

Commonly owned U.S. Pat. Nos. 6,018,739, 6,317,544 and 6,320,974, the contents of which are hereby incorporated by reference, relate to identification systems utilizing biometrics. These systems employ biometric data to rapidly identify individuals, particularly in the context of immigration and naturalization. The above references, however, do not disclose a multi-biometric system for the storage and retrieval of an individual's medical history.

Accordingly, there is a need in the art for a system and method that can quickly identify an individual and retrieve the identified individual's medical history. In doing so, medical professionals can provide enhanced diagnosis and/or treatment to the individual.

### SUMMARY OF THE INVENTION

One aspect of the invention relates to a method of providing quick retrieval of a personal medical history profile. The method includes: maintaining in a database for each of a plurality of individuals a medical history profile and corresponding at least one biometric characteristic; and retrieving the medical history profile from the database based on the at least one biometric characteristic of the individual.

Another aspect of the invention relates to a method of quickly verifying an individual is covered by an insurance policy. The method includes: maintaining in a database for each of a plurality of individuals an insurance policy profile and a corresponding at least one biometric characteristic; retrieving the insurance policy profile from the database based on the at least biometric characteristic of the individual; and identifying from the insurance policy profile whether the individual is entitled to insurance coverage.

Another aspect of the invention relates to a system for storing and retrieving data relating to human lifecycle data. The system includes: at least one host computer, comprising a first processor, a first memory, and a first communication interface for transferring data to/from the memory; and at least one database stored in the first memory, said database including at least one biometric characteristic entry for storing a biometric characteristic that uniquely identifies an individual, and at least one medical history profile entry for storing a medical history profile of the individual, wherein the at least one biometric characteristic entry is associated with the at least one medical history profile entry.

Yet another aspect of the invention relates to a method of transacting business in conjunction with medical services. The method includes: obtaining biometric characteristics of a plurality of individuals, wherein the biometric characteristics uniquely identify each individual; maintaining on at least one server the biometric characteristics and a medical history profile for each of the plurality of individuals; correlating the biometric characteristics of each individual of the plurality of individuals to the respective medical history profile of each individual; and at a later time, obtaining biometric characteristics of at least one individual of the plurality of individuals to retrieve the at least one individual's medical history profile.

Another aspect of the invention relates to a portable multiple biometric enrollment system (MBES). The MBES includes: at least one biometric reader for obtaining biometric data; a memory; a communication interface for transmitting and receiving data; a processor operatively coupled to the at least one biometric reader, the memory and the communication interface; and code residing in the memory and executed by the processor, wherein the code causes the processor to instruct the biometric reader to collect the biometric data of an individual, instruct the communication interface to transmit the biometric data to a host computer and to receive a medical history profile from the host computer, said medical history profile corresponding to the collected biometric data.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

These and further features of the present invention will be apparent with reference to the following description and drawings, wherein:

FIG. 1 is a schematic diagram illustrating implementation of a system in accordance with the present invention;

FIG. 2 is a simplified system diagram illustrating a front end biometric station and a backend database management system in accordance with an embodiment of the present invention;

FIG. 3A is a side schematic view of a front end biometric station in accordance with an embodiment of the invention;

FIG. 3B is a top schematic view of the front end biometric station of FIG. 3A;

FIG. 4 is a schematic diagram illustrating an exemplary application of the present invention;

FIG. 5 is a block diagram illustrating an exemplary database structure in accordance with an embodiment of the invention;

FIG. 6A is a flow diagram illustrating system setup in accordance with an embodiment of the invention;

FIG. 6B is a flow diagram illustrating retrieval of medical information in accordance with an embodiment of the invention; and

FIG. 7 is a schematic diagram illustrating DNA signature data being obtained and entered into the system in accordance with an embodiment of the invention.

### DESCRIPTION OF THE INVENTION

The following is a description of the present invention with reference to the attached drawings, wherein like reference numerals will refer to like elements throughout. To illustrate the present invention in a clear and concise manner, the drawings may not necessarily be to scale.

The present invention relates to a system and method for quickly identifying and retrieving an individual's personal data, such as a medical history profile, insurance data, etc., using biometric, biographic and/or demographic data. A medical history profile, as used herein, is the history of a medical patient and can include, for example, the individual's blood type, current medications taken, previous medications taken, current medical conditions, previous medical conditions, previous medical procedures performed on the individual, allergies, etc. As will be appreciated, any personal information that may be relevant to treating an individual can be considered medical history of the individual. Insurance data can include proof of insurance, level of coverage, number of claims submitted by the individual, etc.

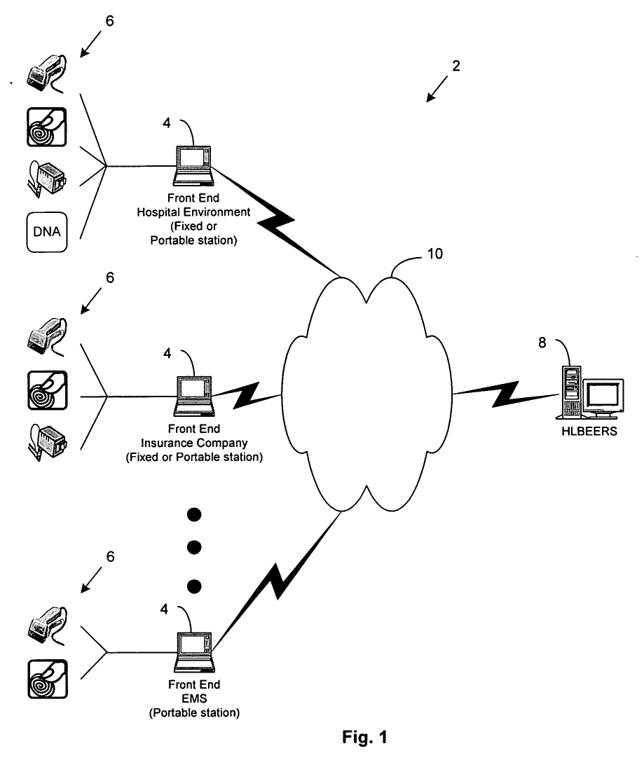

FIG. 1 schematically illustrates a system 2 for collecting, storing and retrieving personal data in accordance with an embodiment of the invention. The system stores and retrieves data by associating the personal data with characteristics unique to each individual. The characteristics can include biometric data, e.g., fingerprint data, iris data, facial data, DNA data, etc., biographic data, e.g., name, date of birth, social security number, etc. and/or demographic data.

The system can be used to retrieve an individual's medical history, to verify an individual is insured, to prevent insurance fraud, or any other field in which quick retrieval of personal data is required. For example, in the medical context, prior to treating a patient the treating facility can verify that the individual has medical insurance by collecting the personal characteristics of the individual. Using the characteristics, insurance information for the individual can be retrieved. Since the collected characteristics are unique to that individual, the likelihood of insurance fraud is minimized. Additionally, the medical history of the individual also can be quickly retrieved, thereby saving valuable time. This is particularly useful in emergency situations, where the patient is unconscious or cannot otherwise be identified. Using the system of the present invention, the individual can be identified and the medical records retrieved, regardless of whether the individual can communicate his or her identification.

The present invention will be described in the context of a medical emergency, wherein the patient is unconscious and/or cannot be identified via conventional means, e.g., drivers license, personal possessions, etc. As was noted above, the present invention has application to numerous other fields and situations, and the context of an unidentifiable individual is not intended to be limiting in any way. Other applications of the invention can include, for example, verification that the individual requesting medical treatment is the actual person he claims to be (e.g., prevention of insurance fraud), identification of patients within a hospital (e.g., identify patient and verify patient has insurance, provide accurate billing to patient), and prevention of medical mistakes (e.g., prevention of drug interactions).

The system 2 includes one or more front end stations 4, which can be used to collect characteristic data and personal data. The front end stations 4 can be portable units or they can be fixed units located in specific areas, e.g., a hospital, an insurance company or the like. Each front end station 4 includes one or more input devices 6 for collecting the characteristic data. As will be described in more detail below, the input devices 6 can be biometric readers (e.g., a fingerprint scanner, an iris scanner a facial scanner, or the like) and/or biographic readers (e.g., a bar code scanner, a keyboard, or the like). Additionally, personal data, such as medical records, insurance records, etc., are collected and associated with the characteristics for each individual.

After the personal data and the characteristic data are collected, the data is transmitted to a back end server 8 for storage and retrieval. In storing the data, the personal data is associated with the characteristic data, such that retrieval of the characteristic data also will facilitate retrieval of the personal data. The personal data and characteristic data can be stored in the backend server 8 via a database, for example. The back end server 8 is communicatively coupled to each front end station 4 via a communication medium 10, such as a wireless phone network, for example. Although a single back end server 8 is shown, it will be appreciated that the back end server 8 can be a distributed system, wherein multiple back end servers 8 store data.

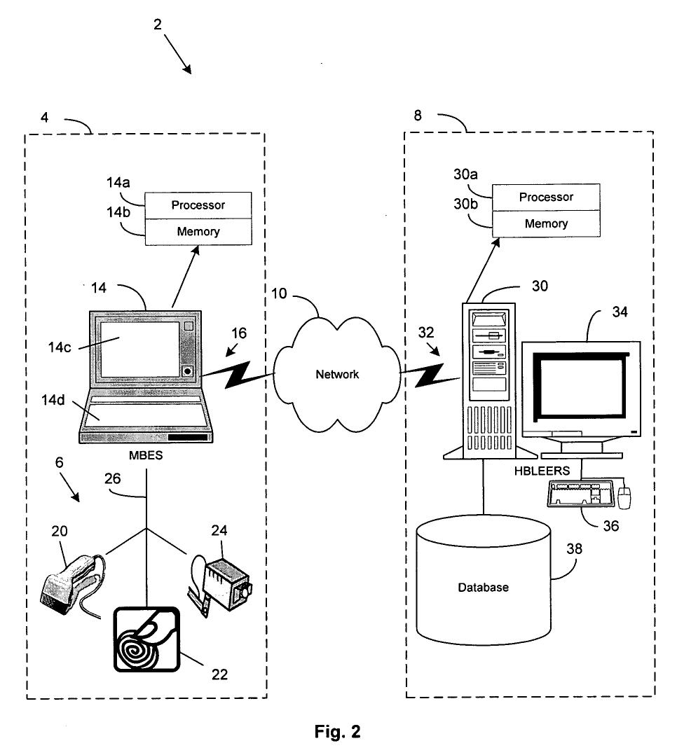

FIG. 2 illustrates in more detail the front end station 4, which also is referred to as a Multiple Biometric Enrollment Station (MBES) 4, and the back end server 8, which also is referred to as a Human Lifecycle Biometrically Enabled E-Health Record System (HLBEERS) 8. The MBES 4 can include a portable computer 14, such as a laptop computer or the like. As is conventional, the portable computer includes a processor 14a, memory 14b, display 14c and user I/O device 14d. The processor can be a conventional processor, such as an AMD Athlon® 64 or an Intel Pentium IV®, for example. Memory, as used herein, can include Random Access Memory (RAM), Read Only Memory (ROM), a magnetic storage medium (e.g., a hard drive, a floppy disk), an optical storage medium (e.g., DVD disk, CD disk) or the like. The display 14c can be any conventional display, such as an LCD display, and the user I/O device 14d can be a conventional keyboard and mouse, touch screen, or the like. As will be appreciated, a desktop computer can be used in the MBES 4 for non-portable configurations.

A network interface 16 provides a communications channel to other devices on a network and/or over the internet, intranet, or the like. The network interface 16 can be a wired or wireless interface. According to one embodiment, the network interface 16 includes an Ethernet interface communicatively coupled to an internet gateway, thereby providing internet access. According to another embodiment, the network interface 16 includes a wireless cellular telephone communication interface.

Communicatively coupled to the portable computer 14 are several input devices 6, such as biometric readers 6. As used herein, a biometric reader is a device that can read, scan, or otherwise obtain biometric data from a biological organism. The biometric readers 6 shown coupled to the portable computer 14 include an iris scanner 20 (e.g., an IRISPASS®-h by Oki Electric Industry Co., Ltd.), a fingerprint scanner 22 (e.g., an MV5™ Fingerprint and Barcode Capture Device by Cross Match Technologies, Inc.) and a camera 24 for facial scans (e.g., a Digicam facial image capture camera by Olympus). As will be appreciated, other biometric readers can be used in conjunction with the MBES 4 without departing from the scope of the invention. The biometric readers 6 are coupled to the portable computer 14 via a communication link 26. The communication link 26 can be a wired (e.g., a universal serial bus or network connection) or wireless (e.g., 802.11a, b, g wireless link, Bluetooth, or the like) communications link.

According to one embodiment of the present invention, the laptop computer 14, iris scanner 20, fingerprint scanner 22, camera 24 and network interface 16 are electronically coupled together and conveniently housed in a carrying case. For example, a two-piece, hinged rugged construction carrying case may be outfitted with a foam template having cutouts for holding in place the various components, a power strip for accepting the power cord connections of the various components and providing 12 volt AC power thereto, and a 12 volt DC inverter having a 12 volt extension cord for coupling the strip to an alternative power source, for example, a cigarette lighter of an automobile. The power strip preferably includes surge suppressor circuitry to protect the various components from damage due to power surges.

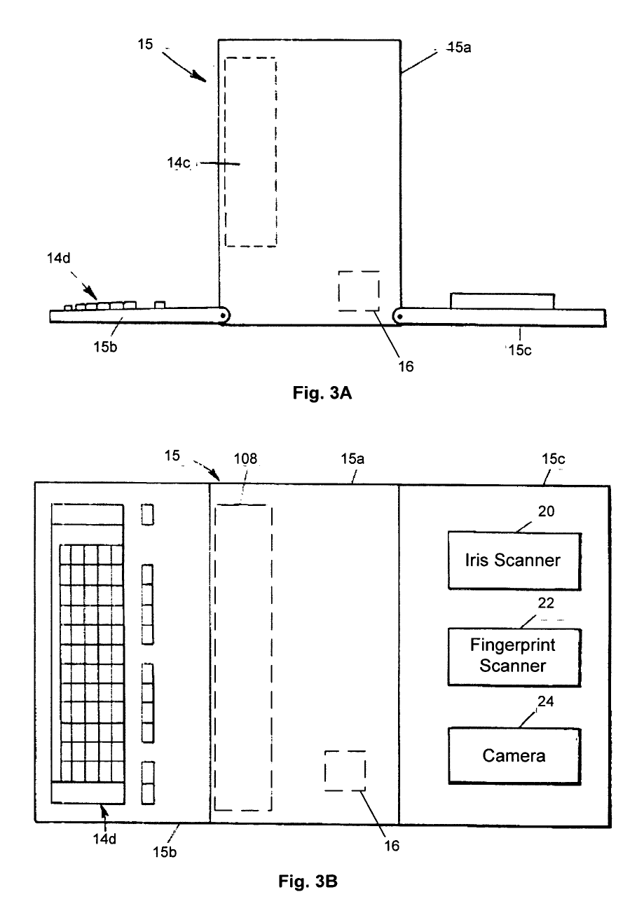

In another embodiment of the invention, the above-described portable computer 14 may be housed in a portable, substantially rectangular, self-contained unit known generally as a “lunchbox” CPU 15, as shown in FIGS. 3A and 3B. The lunchbox, according to the present invention, includes a main body 15a, a front panel 15b and a back panel 15c. The front and back panels are hinged to the main body 15a such that each may be folded up to a stowed position against the main body, or folded down to a deployed position away from the main body. In general, the main body 15a houses the main computing boards (not shown), network interface 16 and display screen 14c, the front panel 15b houses a keyboard 14d, and the back panel 15c houses the iris scanner 20, the fingerprint scanner 22 and the camera 24. When in their stowed positions, the front and back panels 15b, 15c and the main body 15a combine to form the portable lunchbox 15. When the front panel 15b is deployed, it exposes the keyboard 14d and the display screen 14c on the main body 15a. When the back panel 15c is deployed, it exposes the iris scanner 20, fingerprint scanner 22 and camera 24.

The HLBEERS 8 provides backend functionality for the system 2. The HLBEERS 8 provides a variety of functions including receiving biometric data, biographic data and demographic data for storage and retrieval management, transaction management, and iris, fingerprint and image matching functionality, along with one or more databases. These functions are available for use by the operator at the MBES 4. Database functions may include but are not limited to the storage and retrieval of biometric data, biographic data, demographic data, and medical history data, as well as the maintenance of such data.

The HLBEERS 8 includes a server 30 that includes a processor 30a and a memory 30b. As discussed with respect to the portable computer 14, the processor 30a can be a conventional processor, such as an AMD Athlon® 64 or an Intel Pentium IV®, for example. The memory 30b can include Random Access Memory (RAM), Read Only Memory (ROM), a magnetic storage medium (e.g., a hard drive, a floppy disk), an optical storage medium (e.g., DVD disk, CD disk) or the like. The server can be a UNIX server or a Microsoft Windows Server running a number of software clients, as is conventional.

A network interface 32 provides a communications channel to other devices on a network and/or over the internet, intranet, or the like. The network interface 32 can be a wired or wireless interface. According to one embodiment, the network interface 32 includes an Ethernet interface communicatively coupled to an internet gateway, thereby providing internet access. According to another embodiment, the network interface 32 includes a wireless cellular telephone communication interface.

The server 30 also can optionally include a display 34 and a user I/O device 36 (e.g., a keyboard, mouse, touch screen, etc.). Residing in memory 30b of the server 30 is a database 38. As will be described in more detail below, the database 38 includes biometric data, biographic data and/or demographic data (collectively referred to as “identification data”) for each enrolled individual, as well as the individual's medical history. The individual's identification data is correlated with the individual's medical history, such that identifying an individual's identification data within the database 38 also will identify the individual's medical history.

Residing in memory 14b, 30b of the MBES 4 and HLBEERS 8, respectively, is software for controlling the operation of the MBES and HLBEERS. The software is executed by each respective processor 14a, 30a, which control the operation of the various sub-systems of the MBES (e.g. the memory 14b, display 14c, biometric readers 18, network interface 16, etc.) and the HLBEERS 8 (memory 30b, network interface 32, database 38, display 34, etc.), respectively. Such software can readily be created by those having ordinary skill in the art based on the disclosure herein. Consequently, further detail of the software will not be provided.

The MBES 4 and the HLBEERS 8 can exchange data via their respective network interfaces 16, 32 over a wired or wireless communication medium 40. As was noted above, the communication medium 10 can be a wireless telephone communication network, e.g., a cellular phone network, or a communication network (wired or wireless network that is local, regional, national or worldwide in scope) that utilizes the internet and/or intranet. In yet another embodiment, the communication medium 10 is a wireless ad-hoc network based on the 802.11a, b, g standard. Alternatively, the MBES 4 and the HLBEERS 8 can exchange data via a wide area network (WAN), a land-based telephone line, e.g., via a modem, via a satellite communication link, or a removable storage medium, e.g., a removable hard drive, CD-R, DVD±R, or the like.

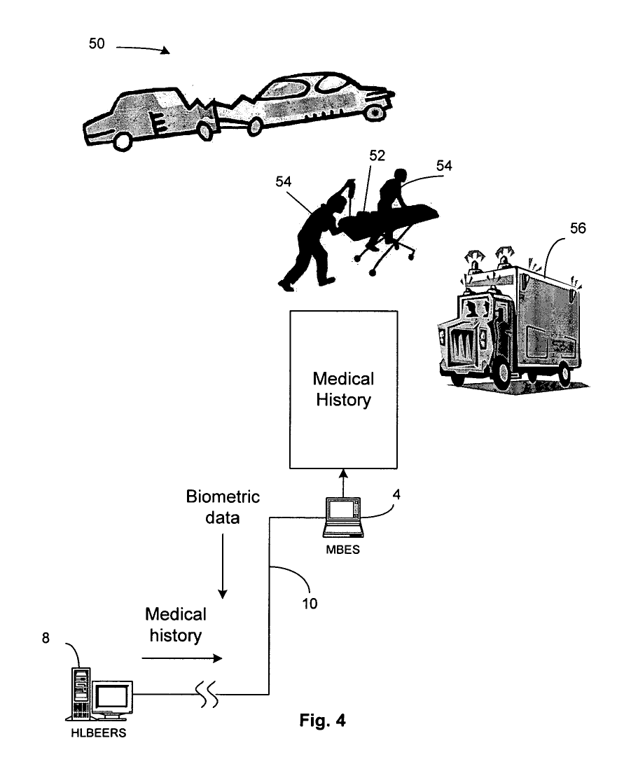

With further reference to FIG. 4, an application of the present invention will be described. In FIG. 4, a hypothetical automobile accident 50 is shown, wherein an individual 52 (e.g., a driver, passenger or pedestrian) involved in the accident 50 is rendered unconscious. The individual 52 is unknown to others in the immediate vicinity of the accident, and the individual is not carrying identification. Medical personnel 54, such as paramedics, arriving at the seen of the accident 50 move the individual 52 to the ambulance 54, where he will receive treatment as he is transported to a hospital. However, since the individual 52 cannot be identified, his medical records cannot be retrieved. Moreover, even if the individual 52 could be identified, retrieval of his medical records could involve significant time, most likely exceeding the window in which treatment is required. Thus, without the individual's medical history, the individual may not receive optimal or speedy treatment.

The present invention overcomes the limitations of the prior art. More specifically, utilizing the MBES 4, biometric data, biographic data and/or demographic data (i.e., the identification data) of the individual is obtained at the scene of the accident 50. The identification data, for example, can be an iris scan, a facial scan, a fingerprint scan, or any other characteristic that uniquely identifies an individual. Such identification data can be obtained regardless of whether the individual is conscious or unconscious. Once obtained, the identification data is communicated to the HLBEERS 8 via the communication medium 40, and the HLBEERS 8 searches the database 38 for data that matches the individual's 52 identification data. Upon finding a match, the individual is positively identified and his corresponding medical history is retrieved from the database 38. The medical history is forwarded to the appropriate medical personnel 54 (e.g., doctors, paramedics, etc.) at the treating facility and/or at the accident site, thus providing valuable information to the medical personnel.

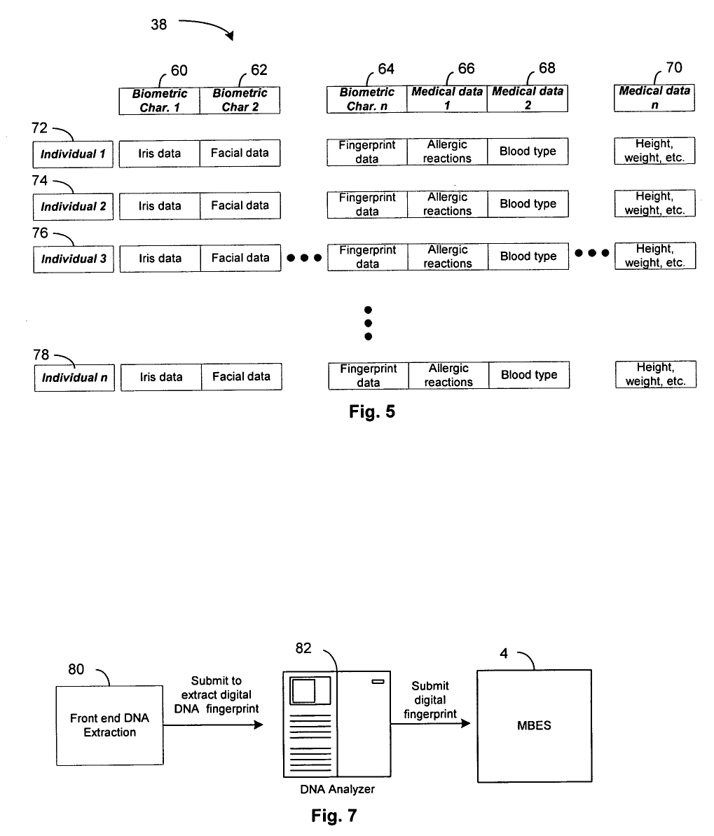

Referring now to FIG. 5, an exemplary structure for the database 38 will be described using a simple row and column format, wherein the intersection of each row and column includes data specific to the respective row and column. It will be appreciated that other database structures can be utilized without departing from the scope of the invention. Additionally, while a single database structure is shown, it will be appreciated by those skilled in the art that the database can be constructed to include multiple databases tables, e.g., a biometric database table, a biographic database table, and a demographic database table.

The database 38 resides in memory 30b of the HLBEERS 8, and includes a number of columns relating to identification data and medical history data, and a number of rows relating to specific individuals. As was noted above, the data contained within the intersection of a particular row and column relates to the specific individual (the row) and the specific data type (the column). The database 38 can be a Microsoft SQL database, for example.

A first biometric characteristic column 60 pertains to a first biometric characteristic data, such as iris scan data, fingerprint scan data, facial scan data, etc. As will be appreciated by those skilled in the art, the format of the biometric data stored in the database 38 can be any conventional format utilized in storing biometric data. The database 38 can include a second biometric characteristic column 62, a third biometric characteristic, a fourth biometric characteristic, etc., until a final n^{th} biometric characteristic column 64 is utilized. According to one embodiment, the database 38 includes a single biometric characteristic column and, in another embodiment, the database 38 includes a plurality of biometric characteristic columns, e.g., multiple iris, multiple fingerprint and/or multiple facial data for each enrolled individual.

The database also includes one or more medical history columns 66, 68, 70. Each medical history column includes data pertaining to personal medical history and/or characteristics of an individual.

Although not shown, the database 38 can include a number of other columns for storing other information. These columns can include biographical data, e.g., name, social security number, date of birth, gender, next of kin, etc., a system identification number, e.g., an E-health record number, general information, e.g., phone number, address, insurance carrier, name of the preferred physician, demographic data, e.g., DNA signature data, or any other information that is useful in treating the individual and/or maintaining the database.

The database 38 also includes a number of rows 72, 74, 76, 78 that pertain to specific individuals. Each individual enrolled in the system 2 is allocated a single row for storage of personal information. As will be appreciated, the number of rows in the database 38 corresponds to the total number of individuals enrolled in the system 2.

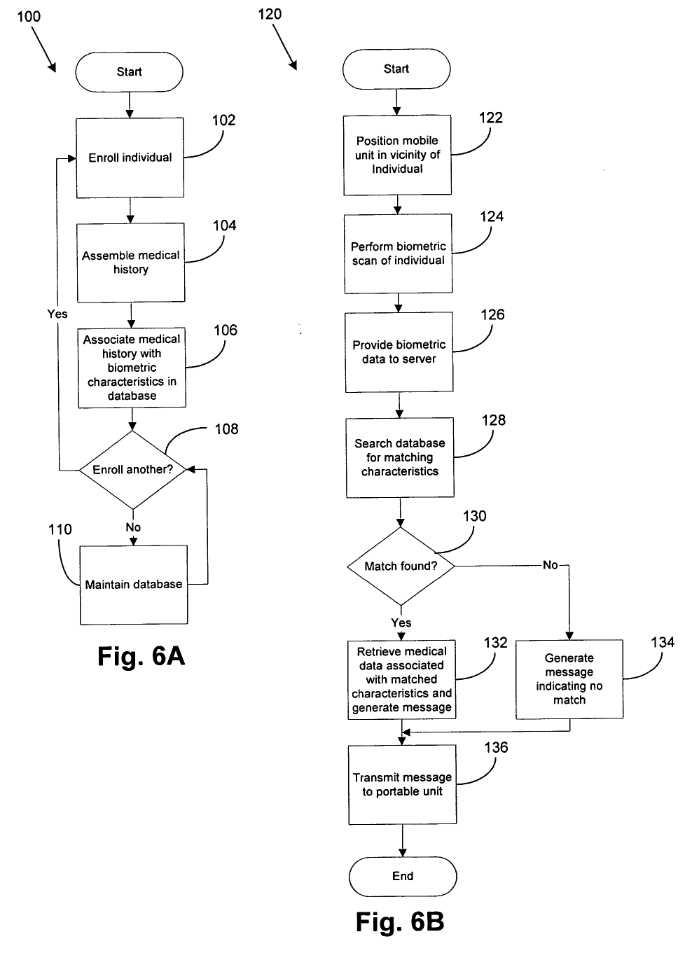

Referring now to the flowchart 100 of FIG. 6A, exemplary steps for collecting identification data that can be used to create the database 38 in accordance with an embodiment of the present invention are shown. The flow diagram includes a number of blocks arranged in a particular order. As should be appreciated, many alternatives and equivalents to the illustrated process may exist and such alternatives and equivalents are intended to fall with the scope of the claims appended hereto. Alternatives may involve carrying out additional steps or actions not specifically recited and/or shown, carrying out steps or actions in a different order from that recited and/or shown, and/or omitting recited and/or shown steps. Alternatives also include carrying out steps or actions concurrently or with partial concurrence.

Beginning at step 102, an individual is enrolled into the system 2. In accordance with the present invention, enrollment is the process of collecting identification data from the individual and associating the collected identification data with the respective individual. The biometric data can be iris data, fingerprint data, facial data, or the like. The enrollment process can be performed with the individual laying down, standing up or sitting down. Moreover, due to the portability of the MBES 4, the enrollment can be performed almost anywhere. Additionally, biographic data, such as a person's name, date of birth, identification number (e.g., social security number), etc., and demographic data also can be collected during the enrollment process (or at a later time) and associated with the individual. The collected data is initially stored in the MBES 4 and later transferred to the HLBEERS 8.

It is noted that while enrollment can be performed in a single sitting, it is contemplated that enrollment be an ongoing process. For example, facial features of children and young adults may change significantly in a short period of time. Thus, biometrics using facial characteristics should be updated periodically to ensure accurate facial data.

The invention can be used to identify and track a human being in its full life cycle development, from birth to death. For example, an individual can be enrolled at birth using biographical data and demographic data. At one to two years of age, the individual can be further enrolled using iris and fingerprint data. Adults can be enrolled using biometric, biographic and demographic data. After death, an individual can be identified using iris, fingerprint and/or DNA data, for example.

During the enrollment process, the processor 14a of the MBES 4, based on instructions from an operator, commands the appropriate biometric readers 20, 22, 24 to collect biometric data. The respective biometric readers perform a scan, thereby collecting biometric data. After completing the biometric scan, the biometric readers communicate the biometric data back to the processor 14a, which stores the data into memory 14b, and the data is associated with the respective individual.

For example, the MBES operator chooses a “search and enroll” feature of the MBES 4. The initiation of “search and enroll” brings up a screen that prompts the operator to first place the individual's left index finger on the fingerprint scanner 22. The screen then prompts the operator to place the individual's right index finger on the fingerprint scanner 22. Quality analysis is performed on the scanned fingerprint data to make sure that the fingerprint image is of sufficient quality. The MBES 4 then prompts the operator to perform an iris scan of the individual using the iris scanner 20. The operator places the iris scanner 20 in front of the individual's left eye and performs a scan, and then the operator places the scanner 20 in front of the individual's right eye and performs a scan. Again, a quality analysis is performed on the iris scans to make sure the iris scans are of sufficient quality. The MBES 4 then turns on the camera 24 and prompts the user to snap a photograph of the individual.

After the picture is taken, the operator is returned to the entry screen for entry of non-biometric data (e.g., biographic data, demographic data). The user then enters the individual's biographic data, e.g., name, birth date, age, etc., and/or demographic data. The MBES 4 associates the biometric, biographic and demographic data with the respective individual.

With respect to DNA data, a sample is obtained from the individual, e.g., a blood sample, hair sample, etc., and a DNA extraction 80 is performed in a laboratory environment, as indicated in FIG. 7. A DNA analyzer 82 produces a digital DNA fingerprint, which then is entered into the MBES 4 and associated with the respective individual.

Upon completion of obtaining the identification data, a submit button is pressed (e.g., a soft button on the display 14c). The submit button initiates sending the data from the MBES 4 to the HLBEERS 8. As will be appreciated, all identification data as well as the individual's medical history need not be entered into the MBES 4 at the time the individual is initially enrolled. Instead, some data can be collected and entered into the database 38 at a later time. However, at least one type of identification data is required to enroll the individual.

Once the individual is enrolled, the data is communicated to the HLBEERS 8 for future matching. As was noted above, data can be exchanged between the MBES 4 and the HLBEERS 8 via a wired or wireless communication medium 40, e.g., a cellular phone network, the internet, or the like. Alternatively, data stored on the MBES 4 can be transferred to the HLBEERS 8 via removable storage medium, e.g., CD, DVD, floppy disk, or the like.

In communicating the data to the HLBEERS 8, the processor 14a of the MBES 4 retrieves the data from memory 14b and provides the data to a transmit buffer (not shown) of the network interface 16. The processor 14a then instructs the network interface 16 to transmit the data from the transmit buffer to the HLBEERS 8 via the communication medium 40. The network interface 32 of the HLBEERS 8 receives the data and stores the data in a receive buffer (not shown). The processor 30a of the HLBEERS 8 moves the data from the network interface 32 into memory 30b. The data then is placed in the database 38 for storage and retrieval of the data, as described below.

If the communication medium 10 is a removable storage medium, then the processor 14a instructs a storage device (e.g., a DVD drive, a CD drive, a floppy drive—not shown) to write the data to the storage medium (e.g., a DVD±R disk, a CD-R disk, a floppy disk). Once the data has been written to the medium, the medium is removed from the MBES 4 and placed in a storage device (e.g., a DVD drive, a CD drive, a floppy drive—not shown) of the HLBEERS 8. The processor 30a of the HLBEERS 8 instructs the storage device to read the data from the storage medium, and places the read data into the database 38 for storage and future retrieval.

Moving to step 104, the medical history specific to the newly enrolled individual is assembled. As will be appreciated, the medical history can be assembled from the individual's medical records, e.g., hospital records, doctor's records, or the like. Upon assembling the individual's medical history, the medical history data is entered into the database 38 at step 106.

More specifically, the identification data previously collected is entered into the database 38 corresponding to the respective identification column (e.g., biometric columns 60, 62, 64) and the respective individual row 72, 74, 76, 78. Additionally the individual's medical history data is entered into the database 38 corresponding to respective medical history column 66, 68, 70 and the respective individual row 72, 74, 76, 78. In this manner, the identification data is associated with the medical history data, such that upon searching and finding a match of specific identification data, the medical history data associated with the identification data can be retrieved. As will be appreciated, the medical history data can be directly entered into the database 38 via the HLBEERS 8, or entered into the MBES 4 or a separate workstation (not shown), and later transferred to the database 38 residing in the HLBEERS 8.

Next at step 108, it is determined whether another individual will be enrolled into the system 2. If another individual will be enrolled, the processor 14a moves back to step 102 and steps 102-106 are repeated for the new individual. If, on the other hand, another individual will not being enrolled, then at step 110 the database 38 is maintained. Maintenance of the database 38 includes updating each individual's medical history (e.g., adding new data to the database 38 as it is recorded and/or obtained) and purging old records from the database (e.g., removing records of deceased individuals). In order to achieve optimum results, maintenance of the database 38 should be an ongoing process.

Referring now to the flowchart 120 of FIG. 6B, exemplary steps for retrieving an individual's medical history from the database 38 in accordance with an embodiment of the present invention are shown. Beginning at step 122, the MBES 4 is brought to the location of the individual 52 for whom a medical history is sought, e.g., at the site of an accident 50. Next at step 124, identification data of the individual 52 are obtained. The identification data can be from one or more iris scans, fingerprint scans, and/or facial scans using the respective biometric readers 20, 22, 24. As will be appreciated, other types of biometric scans may be implemented without departing from the scope of the invention. Also, biographic and/or demographic data can be entered into the MBES 4.

For example, an operator places the individual's left index finger on the fingerprint scanner 22 and, sequentially or consecutively, places the iris scanner 20 in front of the left eye of the individual. The operator then instructs the MBES 4 to perform biometric scans, e.g., an iris scan and a fingerprint scan. Based on the instruction, the processor 14a, via the communication link 26, commands the iris scanner 20 and the fingerprint scanner 22 to perform a scan operation. The iris scanner 20 and the fingerprint scanner 22 perform their respective scans and, via the communication link 26, transmit the biometric data to the processor 14a of the MBES 4. The processor 14a receives the data and temporarily stores the biometric data in memory 14b.

Biographic data can be entered into the MBES 4 by manually typing the data into the MBES 4 via the I/O device 14d, or by reading the data from a storage medium (e.g., DVD disk, CD disk, floppy disk). Additionally, biographic data can be scanned into the MBES 4 using the barcode reading capabilities of the fingerprint scanner 22. For example, an individual's insurance card can include bar code data that indicates a specific identification number of the insurance carrier. Based on this identification number, the MBES 4, via the network interface 16, can access a secure web site containing further biographic and/or demographic data for the individual. The MBES 4 then can download this data and associate the data with the respective individual.

With respect to DNA data, a sample is obtained from the individual, e.g., a blood sample, hair sample, etc., as was done during the enrollment process. A DNA extraction 80 is performed on the sample in a laboratory environment, and a DNA analyzer 82 produces a digital DNA fingerprint of the individual. The DNA fingerprint then is entered into the MBES 4.

Next at step 126, the identification data just obtained is transferred from the MBES 4 to the HLBEERS 8. According to one embodiment, the processor 14a retrieves the data from memory 14b and places the data in a transmit buffer of the network interface 36. The processor 14a then instructs the network interface 16 to transmit the data from the transmit buffer to the HLBEERS 8 via the communication medium 40. The network interface 32 of the HLBEERS 8 receives the data from the communication medium 10 and stores the data in a receive buffer. The processor 30a of the HLBEERS 8 moves the data from the receive buffer and temporarily stores the data into memory 30b. In another embodiment, the processor 14a of the MBES 4 instructs a storage device (e.g., a hard drive, optical drive or the like) to write the data to a storage medium (e.g. CD-R, DVD-R, magnetic disk or the like). The storage medium then is removed from the MBES 4 and transferred to the HLBEERS 8, wherein the processor 30a of the HLBEERS 8 instructs a corresponding storage device to read the data from the storage medium, and the processor 30a temporarily stores the read data in memory 30b.

At step 128, the processor 30a performs a search of the database 38. More specifically, the processor 30a searches for data in the database 38 that matches the identification data temporarily stored in memory 30b. As indicated at step 130, if a match is found the processor 30a moves to step 132 and retrieves from the database 38 the medical history data corresponding to the matched identification data. If, however, a match is not found, then at step 134 the processor 30a generates a message indicating that a match for the data could not be found. Next at step 136, the processor 30a instructs the network interface 36 to transmit the medical history (or the message) to the MBES 4 via the communication medium 40. The MBES 4 receives the data via the network interface 16, and the processor 14a of the MBES temporarily stores the data in memory 14b. The processor then outputs the data to the display 14c for viewing by the medical personnel.

Additionally, different biometric data can be “fused” to improve the accuracy of the identification process. The term fused, as used herein, refers to using multiple types of biometric data to perform a search of the database. For example, the identification process can be based on multiple and different biometric data, e.g., iris biometric data and fingerprint biometric data. Finding a match in the database for multiple biometric data increases the accuracy of the identification process. Consequently, the likelihood that an imposter can “fool” or circumvent the identification process is minimized.

Accordingly, the present invention facilitates the identification of an individual and retrieval of the individual's medical history. Moreover, the medical history can be retrieved when the identity of the individual is not known, thereby increasing the likelihood that the individual will receive optimal diagnosis and treatment.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of providing quick retrieval of a personal medical history profile, the method comprising the steps of:
maintaining in a database for each of a plurality of individuals a medical history profile and corresponding at least one biometric characteristic; and
retrieving the medical history profile from the database based on the at least one biometric characteristic of the individual.

2. The method of claim 1, wherein maintaining in the database at least one biometric characteristic includes at least one of iris, fingerprint or facial data.

3. The method of claim 1, wherein retrieving the medical history profile based on at the least one biometric characteristic includes using multiple and different biometric characteristic to retrieve the medical history profile.

4. The method of claim 1, wherein maintaining biometric characteristic includes maintaining multiple and different biometric characteristics of the same individual.

5. The method of claim 1, further comprising using a database having at least one of biographic or demographic data.

6. The method of claim 5, wherein using a database having biographic data includes using at least one of a name, an identification number, a date of birth, a next of kin, a gender, a phone number an address, an insurance carrier or a name of a preferred physician of the individual.

7. The method of claim 1, wherein maintaining in the database medical history profile includes using at least one of blood type, allergies, current medical conditions, current medications taken, previous medical conditions and previous medical procedures performed on the individual as the medical history profile.

8. The method of claim 1, wherein the medical history profile includes the name of drugs currently prescribed to the individual, further comprising using the medical history to identify potential drug interactions with the current drugs and proposed drugs.

9. The method of claim 1, wherein maintaining in the database at least one biometric characteristic includes using a DNA signature as the biometric characteristic.

10. A method of quickly verifying an individual is covered by an insurance policy, the method comprising the steps of:
maintaining in a database for each of a plurality of individuals an insurance policy profile and a corresponding at least one biometric characteristic;
retrieving the insurance policy profile from the database based on the at least biometric characteristic of the individual; and
identifying from the insurance policy profile whether the individual is entitled to insurance coverage.

11. The method of claim 10, wherein maintaining in the database at least one biometric characteristic includes maintaining at least one biometric characteristic from the group consisting of iris, fingerprint and facial data.

12. The method of claim 11, wherein retrieving the insurance policy profile based on at least one biometric characteristic includes using multiple and different biometric characteristics to retrieve the insurance policy profile.

13. The method of claim 11, wherein maintaining in the database includes maintaining biographic data and demographic data in the database.

14. The method of claim 13, wherein maintaining a database having biographic data includes using at least one of a name, an identification number, a date of birth, a next of kin, a gender, a phone number an address, an insurance carrier or a name of a preferred physician of the individual.

15. The method of claim 11, wherein maintaining biometric characteristics includes maintaining multiple and different biometric characteristics of the same individual.

16. A system for storing and retrieving data relating to human lifecycle data, comprising:
at least one host computer, comprising
a first processor;
a first memory; and
a first communication interface for transferring data to/from the memory; and
at least one database stored in the first memory, said database including
at least one biometric characteristic entry for storing a biometric characteristic that uniquely identifies an individual, and
at least one medical history profile entry for storing a medical history profile of the individual, wherein the at least one biometric characteristic entry is associated with the at least one medical history profile entry.

17. The system of claim 16, further comprising at least one of a biographic characteristic entry or demographic characteristic entry.

18. The system of claim 17, wherein the biographic characteristic entry is at least one of a name, an identification number, a date of birth, a next of kin, a gender, a phone number an address, an insurance carrier or a name of a preferred physician of the individual.

19. The system of claim 16, wherein the at least one biometric characteristic entry is selected from the group consisting of iris, face and fingerprint data.

20. The system of claim 16, wherein the medical history profile includes at least one of blood type, allergies, current medical conditions, current medications taken, previous medical conditions and previous medical procedures performed on the individual.

21. The system of claim 16, wherein the interface is at least one of a network interface and a removable storage interface.

22. The system of claim 16, wherein the interface is a wireless interface.

23. The system of claim 22, wherein the wireless interface is at least one of a cellular phone interface or an 802.11a, b, g ad-hoc network.

24. The system of claim 16, wherein the interface is communicatively coupled to at least one of the internet or an intranet.

25. The system of claim 16, wherein the interface is communicatively coupled to a wide area network (WAN).

26. The system of claim 16, further comprising a portable multiple biometric enrollment station (MBES), said MBES comprising:
at least one biometric reader for obtaining the biometric characteristic;
a second memory;
a second communication interface for transferring and receiving data; and
a second processor operatively coupled to the at least one biometric reader, the second memory and the second communication interface,
wherein when the biometric characteristic is obtained from an individual, the second processor transmits the biometric characteristic to the at least one host computer via the second communication interface, and receives from the host computer a medical history profile corresponding to the transmitted biometric characteristic.

27. The system of claim 26, wherein the biometric readers are selected from the group consisting of an iris-scanner, a fingerprint scanner, and a camera.

28. The system of claim 25, wherein the fingerprint scanner further comprises a bar code scanner.

29. The system of claim 26, wherein the first and second communication interface are at least one of a network interface or a removable storage interface.

30. The system of claim 26, wherein at least one of the first or second communication interface is a wireless communication interface.

31. The system of claim 30, wherein the wireless communication interface is at least one of a cellular phone interface or an 802.11a, b, g ad-hoc network.

32. The system of claim 26, wherein at least one of the first or second communication interface is coupled to at least one of the internet or an intranet.

33. The system of claim 26, wherein the first and second communication interface are coupled to a wide area network (WAN).

34. A method of transacting business in conjunction with medical services, the method comprising the steps of:
obtaining biometric characteristics of a plurality of individuals, wherein the biometric characteristics uniquely identify each individual;
maintaining on at least one server the biometric characteristics and a medical history profile for each of the plurality of individuals;
correlating the biometric characteristics of each individual of the plurality of individuals to the respective medical history profile of each individual; and
at a later time, obtaining biometric characteristics of at least one individual of the plurality of individuals to retrieve the at least one individual's medical history profile.

35. A portable multiple biometric enrollment system (MBES), comprising:
at least one biometric reader for obtaining biometric data;
a memory;
a communication interface for transmitting and receiving data;
a processor operatively coupled to the at least one biometric reader, the memory and the communication interface; and
code residing in the memory and executed by the processor, wherein the code causes the processor to
instruct the biometric reader to collect the biometric data of an individual,
instruct the communication interface to transmit the biometric data to a host computer and to receive a medical history profile from the host computer, said medical history profile corresponding to the collected biometric data.
